(19) United States
(12) Patent Application Publication
(10) Pub. No.: US 2006/0140347 A1
(43) Pub. Date: Jun. 29, 2006

(54) Network telephone system and main apparatus of the network telephone system

(75) Inventor: Takanori Kaji, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/297,447

(22) Filed: Dec. 9, 2005

(30) Foreign Application Priority Data
Dec. 9, 2004 (JP) 2004-357069

(51) Int. Cl. H04M 1/24; H04M 3/08

(52) U.S. Cl. 379/2; 379/1.01

(57) ABSTRACT

A main apparatus is used in a network telephone system for connecting a plurality of main apparatuses each accommodating at least one telephone terminal, through a communication network for packet transmission. The main apparatus includes a communication unit and a detection unit. The communication unit transmits and receives a connection confirmation signal used to confirm connection between the main apparatus and another main apparatus when a connection request is issued between telephone terminals on the communication network. The connection confirmation signal is defined by a communication protocol on the communication network. The detection unit detects a connection fault on the communication network on a basis of a result of the transmitting/receiving of the connection confirmation signal by the communication unit.

This application is based upon and claims the benefit of priority from the prior Japanese Patent Application No. 2004-357069 filed on Dec. 9, 2004, the entire contents of which are incorporated herein by reference.

### BACKGROUND OF THE INVENTION

1. Field of the Invention

This invention relates to a network telephone system for performing voice communications between telephone terminals through the IP network, such as an IP (Internet Protocol) telephone system, and a main apparatus of the network telephone system.

2. Description of the Related Art

In recent years, a network telephone system (IP telephone system) for transmitting and receiving an image and voice as packet data bidirectionally in real time through a packet network has become widespread. In the IP telephone system, it is matter of course that extension-to-extension communications and making/receiving of outside call in each main apparatus can be conducted. Also, extension-to-extension communications and making/receiving of outside call between main apparatuses through the packet network can be conducted. In the IP telephone system, voice communications and data communications are conducted in accordance with IP-QSIG protocol.

By the way, in this kind of IP telephone system, if a fault occurs on the packet network, voice communications and data communications cannot be conducted at all. Hitherto, JP Hei. 8-181773 A discloses such a technique that a main apparatus monitors time during which communication established by the main apparatus is interrupted, and if a response does not come within predetermined time, the main apparatus presumes that connection failure occurs and takes measures immediately.

### SUMMARY OF THE INVENTION

By the way, JP Hei. 8-181773 detects a fault such as disconnection or packet non-arrival on the network layer or the lower layers only according to a protocol detection method on the transport layer (for example, TCP 3-way handshake or TCP keep alive). If connection fault occurs during telephone conversation or if connection cannot be established at the calling time, the connection fault cannot be detected or it takes a long time to detect the connection fault. Therefore, it becomes difficult to take measures such as a relief measure with respect to the fault-occurring call. Particularly, in the IP-QSIG protocol, a network fault detection method is not clearly defined. Thus, fault needs to be detected by some means.

The invention provides a network telephone system for making it possible to reliably detect fault in a short time even if the fault occurs in any connection on a communication network in a telephone system using IP-QSIG, and a main apparatus used in the network telephone system.

According to one embodiment of the invention, a main apparatus is used in a network telephone system for connecting a plurality of main apparatuses each accommodating at least one telephone terminal, through a communication network for packet transmission. The main apparatus includes a communication unit and a detection unit. The communication unit transmits and receives a connection confirmation signal used to confirm connection between the main apparatus and another main apparatus when a connection request is issued between telephone terminals on the communication network. The connection confirmation signal is defined by a communication protocol on the communication network. The detection unit detects a connection fault on the communication network on a basis of a result of the transmitting/receiving of the connection confirmation signal by the communication unit.

According to this configuration, when a connection request is issued between the telephone terminals on the communication network, the connection confirmation signal, which is defined by the communication protocol on the communication network and is used to confirm the connection between the main apparatus and the other main apparatus, is transmitted and received. By checking presence/absence of a response to the connection confirmation signal, connection fault on the network layer or the lower layers than the network layer can be detected. Therefore, if fault occurs in any connection on the communication network, the fault can be reliably detected in a short time.

The communication unit may transmit and receive at least one of information indicating a special access number for telephony function provided by telephone system, predetermined invalid dial information and time information, as the connection confirmation signal.

According to this configuration, the information indicating the special access number for the telephony function provided by the telephone system, invalid dial information, or the time information is used as the connection confirmation signal. Therefore, the connection confirmation signal can be handled in a similar manner to other access numbers, and it is not necessary to define a new connection confirmation signal by protocol. Also, means for detecting connection fault on the network layer or the lower layers in conformity with the IP-QSIG protocol can be provided.

The main apparatus may further include an interface capable of arbitrarily setting at least one of a transmission method, transmission interval, transmission direction, transmission timing, and fault detection time of the connection confirmation signal.

According to this configuration, the interface is provided, whereby the optimum connection fault detection processing can be performed in response to the use environment, etc., of the main apparatus.

As described above in detail, according to the above-described configurations, the network telephone system makes it possible to reliably detect fault in a short time even if the fault occurs in any connection on a communication network in a telephone system using IP-QSIG. Also, the main apparatus used in the network telephone system can be provided.

### BRIEF DESCRIPTION OF THE DRAWINGS

In the accompanying drawings:

FIG. 1 is a schematic block diagram to show a network telephone system according to a first embodiment of the invention;

FIG. 2 is a block diagram to show the functional configuration of a main apparatus used in the first embodiment of the invention;

FIG. 3 is a drawing to show an example of the storage contents of a storage section shown in FIG. 2;

FIG. 4 is a sequence chart to describe the telephone conversation operation between telephone terminals via an IP network at the normal time in the first embodiment of the invention;

FIG. 5 is a sequence chart to show an operation example when a connection fault occurs before a communication link is established in the first embodiment of the invention;

FIG. 6 is a sequence chart to show an operation example when a connection fault occurs after a communication link is established in the first embodiment of the invention;

FIG. 7 is a flowchart to show a processing procedure of a control section of the main apparatus in detecting a connection fault before a communication link is established in the first embodiment of the invention;

FIG. 8 is a flowchart to show a processing procedure of the control section of the main apparatus in detecting a connection fault after a communication link is established in the first embodiment of the invention;

FIG. 9 is a block diagram to show the functional configuration of a main apparatus as a second embodiment of the invention; and

FIG. 10 is a drawing to show an example of the storage contents of a storage section shown in FIG. 9.

### DETAILED DESCRIPTION OF EMBODIMENTS OF THE INVENTION

Referring now to the accompanying drawings, embodiments of the invention will be described.

### First Embodiment

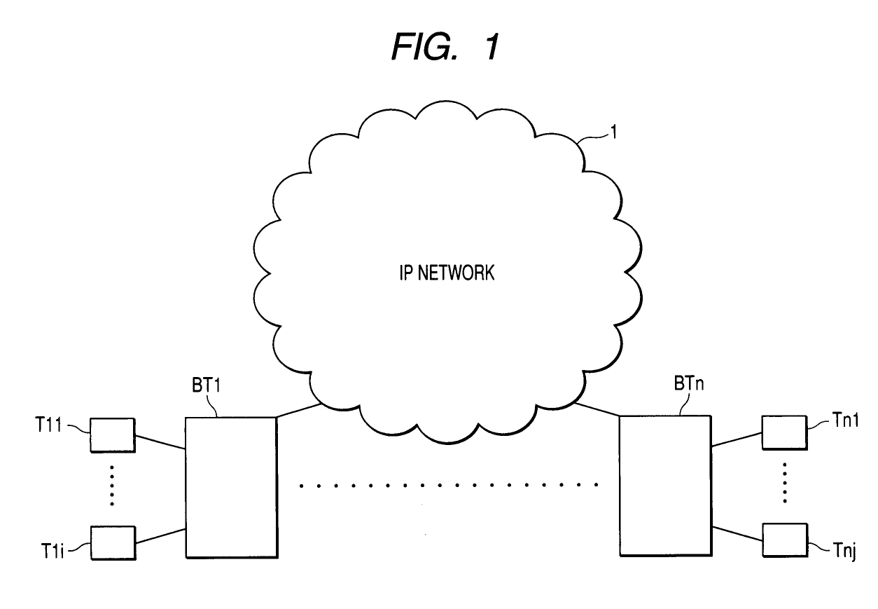

FIG. 1 is a schematic block diagram to show a network telephone system according to a first embodiment of the invention.

The network telephone system has an IP (Internet Protocol) network 1. A plurality of main apparatuses BT1 to BTn (n is a natural number) are connected to the IP network 1. Telephone terminals T11 to T1i (i is a natural number) and Tn1 to Tnj (j is a natural number) are connected to the main apparatuses BT1 to BTn.

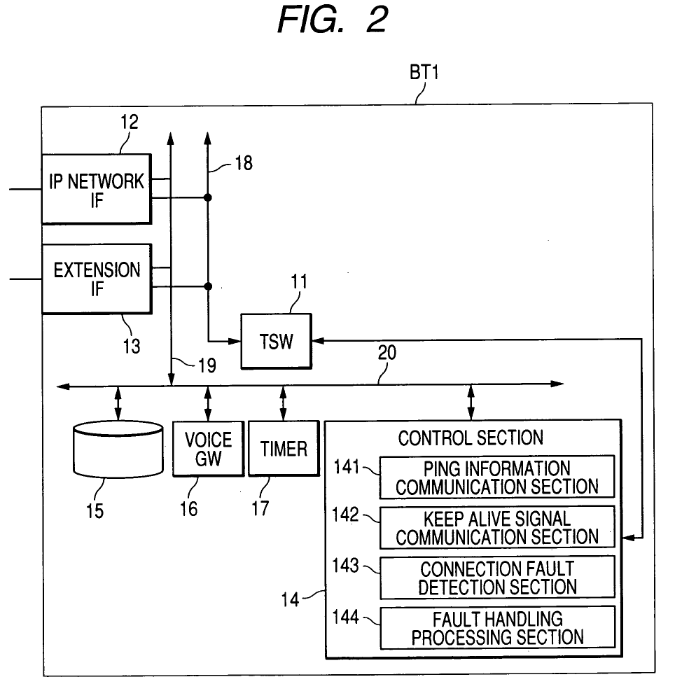

Each of the main apparatuses BT1 to BTn has the following functions. FIG. 2 is a block diagram to show the configuration of the main apparatus. Here, the main apparatus BT1 will be discussed.

The main apparatus BT1 includes a time switch (TSW) 11, an IP network interface section (IP network IF) 12, an extension interface section (extension IF) 13, a control section 14, a storage section 15, a voice gateway (voice GW) 16, and a timer 17. The time switch 11, the IP network interface section 12, and the extension interface section 13 are connected to each other through a PCM highway 18. The IP network interface section 12 and the extension interface section 13 are connected to each other through a data highway 19.

The control section 14, the storage section 15, the voice gateway 16, and the timer 17 are connected through a CPU bus 20. The time switch 11 is connected directly to the control section 14. The PCM highway 18, the data highway 19, and the CPU bus 20 are connected to each other.

The time switch 11 switches a time slot on the PCM highway 18 under the control of the control section 14, thereby switching the IP network interface section 12 and the extension interface section 13 as desired.

The IP network 1 is connected to the IP network interface section 12, if necessary. The IP network interface section 12 performs the interface operation relating to the connected IP network 1. The interface operation includes converting a voice packet given through the IP network 1 into a PCM signal, converting a PCM signal given through the time switch 11 into a voice packet, monitoring the state of the IP network 1 and sending various signals to the IP network 1. The IP network interface section 12 transmits and receives various pieces of control information relating to the interface operation to and from the control section 14 through the data highway 19 and the CPU bus 20.

The telephone terminals T11 to T1i are connected to the extension interface section 13 as required. The extension interface section 13 performs the interface operation relating to the connected telephone terminals T11 to T1i. The extension interface section 13 transmits and receives various pieces of control information relating to the interface operation to and from the control section 14 through the data highway 19 and the CPU bus 20.

The control section 14 controls the time switch 11, the IP network interface section 12, and the extension interface section 13 based on data stored in the storage section 15 and realizes the operation as the main apparatus BT1.

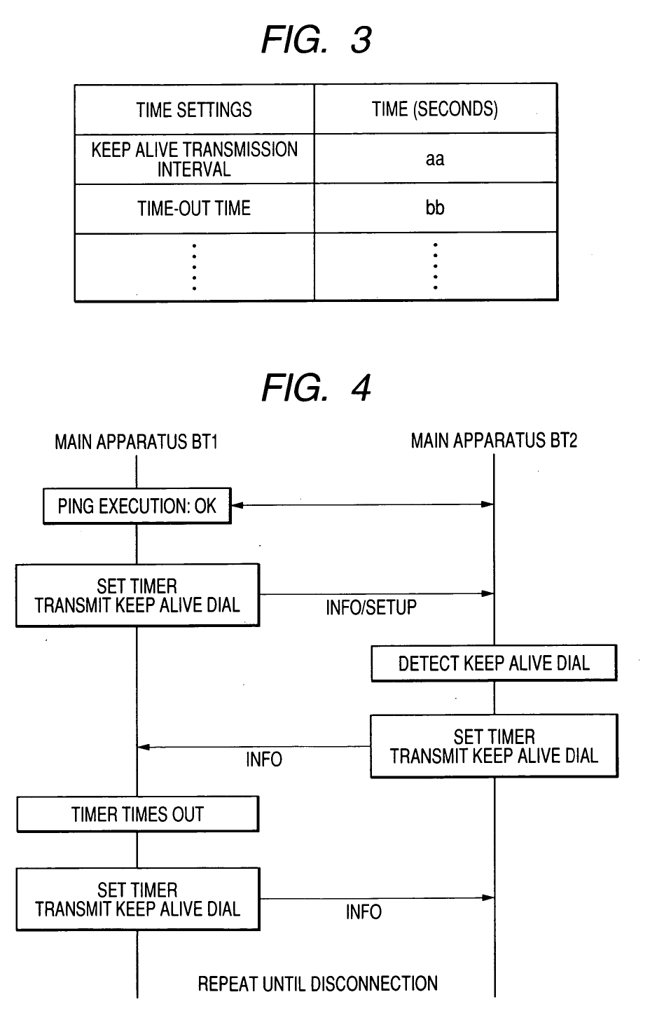

As shown in FIG. 3, the storage section 15 stores a table representing a correspondence relation between (a) timer settings such-as the keep alive signal transmission interval and the time-out time defined by IP-QSIG and (b) those time periods.

The voice gateway 16 executes voice connection processing and voice communication processing.

The timer 17 counts the setup time.

By the way, the control section 14 of the embodiment includes a PING information communication section 141, a keep alive signal communication section 142, a connection fault detection section 143, and a fault handling processing section 144. When a communication link is opened between the telephone terminals T11 and T21, for example, the PING information communication section 141 transmits PING Request defined by IP-QSIG to the main apparatus BT2 and receives PING information sent from the main apparatus BT2. The PING Request is a message to confirm connection between the main apparatus BT1 and BT2.

After a communication link is established between the telephone terminals T11 and T21, for example, the keep alive signal communication section 142 starts the timer 17 and transmits a keep alive signal to the main apparatus BT2 at the keep alive signal transmission interval stored in the table of the storage section 15, and receives a keep alive signal sent from the main apparatus BT2. Invalid dial information is used as the keep alive signal.

The connection fault detection section 143 checks whether or not PING information is sent from the main apparatus BT2 and whether or not a keep alive signal is sent within the time stored in the storage section 15. If PING information or a keep alive signal is not sent, the connection fault detection section 143 determines that a connection fault on the network layer or the lower layers occurred.

When the connection fault detection section 143 detects a fault before a communication link is established, the fault handling processing section 144 switches the communication link to normal connection. When the connection fault detection section 143 detects the fault after the communication link has been established, the fault handling processing section 144 displays a message indicating the fault on a display of the telephone terminal T11.

Next, the operation of the described network telephone system will be described.

Now, assume that the user of the telephone terminal T11 makes a request for having a telephone conversation with the telephone terminal T21 by operating the telephone terminal T11, for example, as shown in FIG. 4. Then, a request signal is sent from the telephone terminal T11 to the main apparatus BT1. Upon receiving the request signal, the main apparatus BT1 transmits PING Request for the main apparatus BT2 to the IP network 1. Upon receiving the PING Request, the main apparatus BT2 sends back PING information according to the sent Request to the main apparatus BT1.

Upon receiving the PING information from the main apparatus BT2, the main apparatus BT1 generates a communication establishment request (SETUP message) addressed to the main apparatus BT2 and transmits the request to the IP network 1. Upon receiving the communication establishment request, the main apparatus BT2 calls up the telephone terminal T21.

If the telephone terminal T21 responds to the call, a response signal (ALERT message and CONN message) is sent through the IP network 1 to the main apparatus BT1. Upon acknowledging the response to the call, the main apparatus BT1 establishes a communication link between the telephone terminals T11 and T21.

Thus, it becomes possible for the user of the telephone terminal T11 to have a telephone conversation with the user of the telephone terminal T21.

At this time, the main apparatus BT1 starts the timer 17 and transmits dial information usually unused to the main apparatus BT2 as a keep alive signal. Upon receiving the keep alive signal sent from the main apparatus BT1, the main apparatus BT2 analyzes the keep alive signal and if the main apparatus BT2 detects that the keep alive signal is dial information defined by IP-QSIG, the main apparatus BT2 sends back a keep alive signal to the main apparatus BT1 according to the keep alive signal transmission interval stored in the table of the storage section 15.

This procedure is repeated until the telephone conversation is disconnected.

Next, the operation when a connection fault occurs before a communication link is established will be discussed.

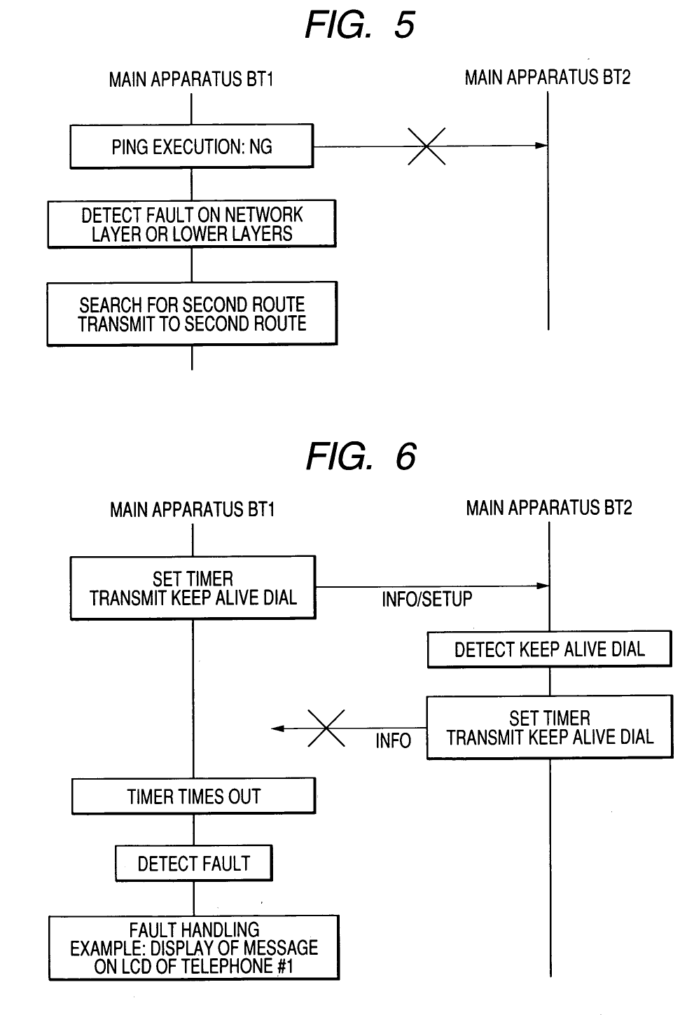

For example, assume that PING information is not sent back from the main apparatus BT2 before a communication link is established between the telephone terminals T11 and T21, as shown in FIG. 5. Then, the main apparatus BT1 determines that a fault on the network layer or the lower layers occurred, searches for a normal route on the IP network 1 and transmits a communication establishment request to the main apparatus BT2 via this route.

Next, the operation when a connection fault occurs after a communication link is established will be discussed.

For example, assume that a keep alive signal is not sent back from the main apparatus BT2 within the time set in the timer 17 after a communication link is established between the telephone terminals T11 and T21, as shown in FIG. 6. Then, the main apparatus BT1 determines that a fault on the network layer or the lower layers occurred, and displays a message indicating the fault on the display of the telephone terminal T11.

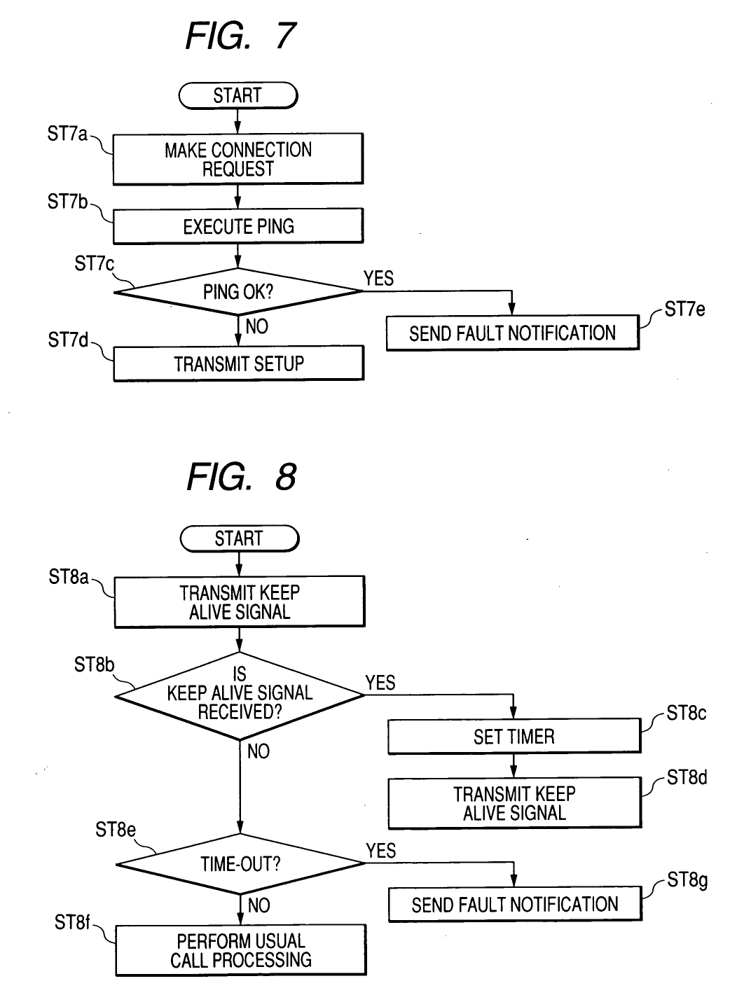

Next, the processing operation of the main apparatus BT1 in executing the above-described operation will be discussed. FIG. 7 is a flowchart to show a processing procedure of the control section 14 of the main apparatus BT1 in detecting a connection fault before a communication link is established.

To begin with, when a connection request from the telephone terminal T11 to the telephone terminal T12 is made (step ST7a), the control section 14 transmits PING Request to the main apparatus BT2 (step ST7b) and determines whether or not PING information responding to the PING Request is sent back from the main apparatus BT2 (step ST7c).

If PING information is sent back from the main apparatus BT2 (YES at step ST7c), the control section 14 generates a SETUP message addressed to the main apparatus BT2 and transmits the SETUP message to the IP network 1 (step ST7d).

On the other hand, if PING information is not sent back from the main apparatus BT2 (NO at step ST7c), the control section 14 determines that a fault on the network layer or the lower layers occurred, searches for a normal route on the IP network 1 and transmits a communication establishment request to the main apparatus BT2 via this route (step ST7e).

FIG. 8 is a flowchart to show a processing procedure of the control section 14 of the main apparatus BT1 in detecting a connection fault after a communication link is established.

To begin with, after a communication link is established between the telephone terminals T11 and T21, the control section 14 transmits a keep alive signal to the main apparatus BT2 (step ST8a), starts the timer 17, and determines whether or not a keep alive signal is sent from the main apparatus BT2 within a predetermined time (step ST8b).

If a keep alive signal is sent from the main apparatus BT2 (YES at step ST8b), the control section 14 again sets the time until keep alive signal comes in the timer 17. (step ST8c) and again transmits a keep alive signal to the main apparatus BT2 (step ST8d).

On the other hand, if a keep alive signal is not sent from the main apparatus BT2 and a time-out does not occur at step ST8e, the control section 14 makes a transition to usual telephone conversation processing (step ST8f); if a time-out occurs, the control section 14 determines that a fault on the network layer or the lower layers occurred, and displays a message indicating the fault on the display of the telephone terminal T11 (step ST8g).

As described above, in the first embodiment, when a connection request occurs between the telephone terminals T11 and T21, for example, using the IP network 1, before a communication link is established, PING information, which is defined by the IP-QSIG protocol and used to confirm connection between the main apparatus BT1 and BT2 is transmitted and received between the main apparatus BT1 and BT2. The presence/absence of a response to the PING information is checked. Thereby, a connection fault on the network layer or the lower layers can be detected.

Therefore, as the PING information is used, if a fault occurs in any connection on the IP network 1 before a communication link is established, the fault can be reliably detected in a short time.

In the first embodiment, after a communication link is established, a keep alive signal, which is defined by the IP-QSIG protocol and is used to confirm connection between the main apparatus BT1 and BT2 is transmitted and received between the main apparatus BT1 and BT2. The presence/absence of a response to the keep alive signal is checked within the predetermined time, to thereby detect a connection fault on the network layer or the lower layers.

Since the keep alive signal is used, if a fault occurs in any connection on the IP network 1 after a communication link is established, the fault can be reliably detected in a short time.

In the first embodiment, invalid dial information is used as the keep alive signal defined by the IP-QSIG protocol. Therefore, it is not necessary for the protocol to define a new keep alive signal, and a connection fault on the network layer or the lower layers can be detected with the simple procedure.

In the first embodiment, if a connection fault on the network layer or the lower layers is detected before a communication link is established, the connection between the telephone terminals T11 and T21 is switched to another normal connection on the IP network 1. Thus, a communication link can be established reliably between the telephone terminals T11 and T21.

Further, in the first embodiment, if a connection fault on the network layer or the lower layers is detected after a communication link is established, a message indicating the fault is displayed on the display of each of the telephone terminals T11 and T21. Thus, the users of the telephone terminals T11 and T21 can immediately know that a connection fault occurred, and therefore can take rapid measures of recovery operation, etc.

### Second Embodiment

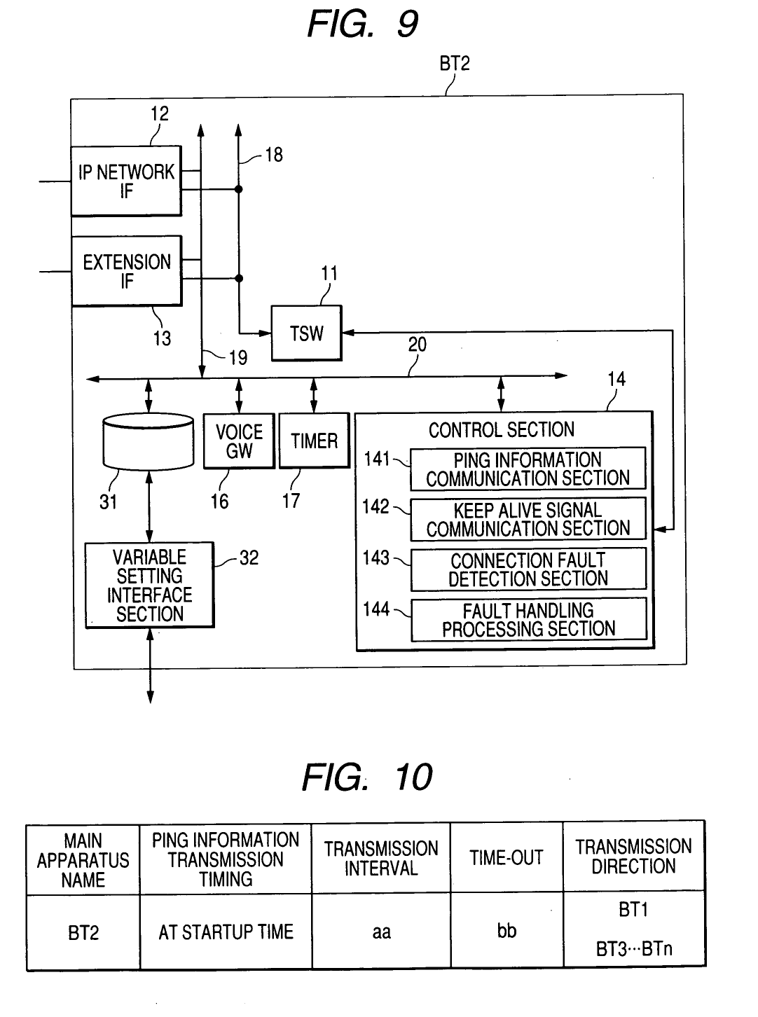

FIG. 9 is a block diagram to show the configuration of each of main apparatus BT1 to BTn as a second embodiment of the invention. Here, the main apparatus BT2 will be discussed. Parts identical with those previously described with reference to FIG. 2 are denoted by the same reference numerals in FIG. 9 and will not be discussed again in detail.

The main apparatus BT2 includes a storage section 31 and a variable setting interface section 32. The storage section 31 stores information indicating the main apparatus BT2, information indicating the transmission timing of PING information, information indicating the transmission time interval of PING information, information indicating time-out of PING information, and information indicating the transmission direction, namely, the called party, as shown in FIG. 10.

The variable setting interface section 32 updates at least one of the PING information transmission timing, the PING information transmission time interval, the time-out, and the transmission direction in accordance with an entered command of the maintenance person of the main apparatus BT2.

A connection fault detection section 143 of a control section 14 sends PING Request to main apparatus BT1 and BT3 to BTn of the called parties stored in the storage section 31 according to the transmission time interval stored in the storage section 31 and causes the main apparatus BT1 and BT3 to BTn to return PING information. If the PING information is not returned, the connection fault detection section 143 determines that a connection fault on the network layer or the lower layers on an IP network 1 occurred.

The PING information is transmitted not only when the main apparatus BT2 is started, but also when the main apparatus BT2 is in the standby state of the main apparatus BT2 and/or an instructions is input from the telephone terminal T22 serving as a maintenance terminal.

As described above, according to the second embodiment, in addition to the communication time, PING Request is sent to the main apparatus BT1 and BT3 to BTn connected to the IP network 1 at regular time intervals, and the main apparatus BT1 and BT3 to BTn are caused to return PING information. If the PING information is not returned, it is determined that a connection fault on the network layer or the lower layers on the IP network 1 occurred. Thus, measures against a connection fault can be taken before a connection request between telephone terminals T21 and T31, for example, on the IP network 1 is made.

In the second embodiment, the main apparatus BT2 includes the variable setting interface section 32. Therefore, the optimum connection fault detection processing can be performed in response to the use environment of the main apparatus BT2.

### Other Embodiments

The invention is not limited to the specific embodiments described above. In the description of the first embodiment, if a connection fault occurs before a communication link is established, the communication link is switched to normal connection on the IP network by way of example. However, the invention is not limited thereto. An ISDN office line, an analog leased line, an analog network, etc., may be used as a bypass.

In the description of the first embodiment, invalid dial information is used as the keep alive signal by way of example. However, the invention is not limited thereto. For example, special access number information, time information included in a telephone terminal may be used.

In addition, system configuration, system type, configuration of the main apparatus, type of the main apparatus, type of the telephone terminal, type of the connection confirmation signal used in the fault detection procedure and/or fault detection can also be modified in various manners without departing from the spirit and the scope of the invention.

What is claimed is:

1. A main apparatus used in a network telephone system for connecting a plurality of main apparatuses each accommodating at least one telephone terminal, through a communication network for packet transmission, the main apparatus comprising:
a communication unit that transmits and receives a connection confirmation signal used to confirm connection between the main apparatus and another main apparatus when a connection request is issued between telephone terminals on the communication network, the connection confirmation signal defined by a communication protocol on the communication network; and
a detection unit that detects a connection fault on the communication network on a basis of a result of the transmitting/receiving of the connection confirmation signal by the communication unit.

2. The main apparatus according to claim 1, wherein the detection unit detects a fault on a network layer or a lower layer than the network layer before communication between the main apparatus and the other main apparatus begins.

3. The main apparatus according to claim 2, wherein the communication unit transmits and receives information indicating a special access number for telephony function provided by a telephone system as the connection confirmation signal.

4. The main apparatus according to claim 2, wherein the communication unit transmits and receives predetermined invalid dial information as the connection confirmation signal.

5. The main apparatus according to claim 2, wherein the communication unit uses a signal to which time information is added as the connection confirmation signal.

6. The main apparatus according to claim 1, further comprising an interface capable of arbitrarily setting at least one of a transmission method, transmission interval, transmission direction, transmission timing, and fault detection time of the connection confirmation signal.

7. A network telephone system for connecting a plurality of main apparatuses each accommodating at least one telephone terminal through a communication network for packet transmission, the network telephone system comprising:
a communication unit that transmits and receives a connection confirmation signal used to confirm connection between a main apparatus accommodating a calling telephone terminal and a main apparatus accommodating a called telephone terminal when the calling telephone terminal issues a connection request between the calling telephone terminal and the called telephone terminal on the communication network, the connection confirmation signal defined by a communication protocol on the communication network; and
a detection unit that detects a connection fault on the communication network on a basis of a result of the transmitting/receiving of the connection confirmation signal by the communication unit.

8. The network telephone system according to claim 7, wherein the detection unit detects a fault on a network layer or a lower layer than the network layer before communication between the calling main apparatus and the called main apparatus begins.

9. The network telephone system according to claim 8, wherein the communication unit transmits and receives information indicating a special access number for telephony function provided by the telephone system as the connection confirmation signal.

10. The network telephone system according to claim 8, wherein the communication unit transmits and receives predetermined invalid dial information as the connection confirmation signal.

11. The network telephone system according to claim 8, wherein the communication unit uses a signal to which time information is added as the connection confirmation signal.

12. The network telephone system according to claim 7, wherein each of the main apparatuses comprises an interface capable of arbitrarily setting at least one of a transmission method, transmission interval, transmission direction, transmission timing, and fault detection time of the connection confirmation signal.
